(19) United States
(12) Patent Application Publication
(10) Pub. No.: US 2018/0203534 A1
(43) Pub. Date: Jul. 19, 2018

(54) TOUCH SENSOR AND METHOD OF DRIVING THE SAME

(71) Applicant: Samsung Display Co., Ltd., Yongin-si (KR)

(72) Inventors: Won Ki HONG, Yongin-si (KR); Tae Hee LEE, Yongin-si (KR)

(21) Appl. No.: 15/828,218

(22) Filed: Nov. 30, 2017

(30) Foreign Application Priority Data
Jan. 19, 2017 (KR) 10-2017-0009245

(51) Int. Cl. G06F 3/041; G06F 3/0488

(52) U.S. Cl. CPC G06F 3/041; G06F 3/0488

(57) ABSTRACT

A touch sensor and a method of driving the same are provided. A touch sensor includes a plurality of first electrodes positioned on a substrate, a plurality of second electrodes positioned on the substrate to be separate from the plurality of first electrodes, an elastic member positioned between the plurality of first electrodes and the plurality of second electrodes, and a controller to apply a driving signal to the plurality of first electrodes and the plurality of second electrodes and to obtain an output signal of the plurality of first electrodes. A shape of the elastic member is changeable in accordance with pressure, and the controller obtains a touch waveform corresponding to concurrently input multiple touches and calculates positions of the multiple touches with reference to a peak of the touch waveform.

### CROSS-REFERENCE TO RELATED APPLICATION

This application claims priority to and the benefit of Korean Patent Application No. 10-2017-0009245, filed on Jan. 19, 2017 in the Korean Intellectual Property Office, the entire content of which is incorporated herein by reference.

### BACKGROUND

### 1. Field

Aspects of embodiments of the present invention relate to a touch sensor and a method of driving the same.

### 2. Description of the Related Art

As interest in information displays and demand on using portable information media increase, research and commercialization on display devices are being actively performed.

Recent display devices include touch sensors for receiving touches of users as well as image displaying functions. Therefore, users may more conveniently use the display devices through the touch sensors.

In addition, recently, various functions are provided to the users by using touch pressures as well as touch positions.

### SUMMARY

According to an aspect, one or more embodiments of the present invention relate to a touch sensor for sensing a touch by using pressure generated by the touch.

According to another aspect, one or more embodiments of the present invention relate to a touch sensor for correctly obtaining positions and intensities of multiple touches.

A touch sensor according to one or more embodiments of the present invention includes: a plurality of first electrodes positioned on a substrate; a plurality of second electrodes positioned on the substrate to be separate from the plurality of first electrodes; an elastic member positioned between the plurality of first electrodes and the plurality of second electrodes; and a controller to apply a driving signal to the plurality of first electrodes and the plurality of second electrodes and to obtain an output signal of the plurality of first electrodes, and a shape of the elastic member is changeable in accordance with a pressure, and the controller obtains a touch waveform corresponding to concurrently input multiple touches and calculates positions of the multiple touches with reference to a peak of the touch waveform.

The touch waveform may represent an intensity of a touch by a position function.

The controller may obtain a touch waveform corresponding to the multiple touches with reference to the output signal.

The controller may obtain a first sub-waveform corresponding to a peak of the touch waveform.

The controller may obtain a second sub-waveform by removing the first sub-waveform from the touch waveform.

When the multiple touches include a first touch and a second touch and an intensity of the second touch is less than an intensity of the first touch, the controller may calculate a position of the first touch from the first sub-waveform.

The controller may obtain the second sub-waveform with reference to a peak of the touch waveform from which the first sub-waveform is removed.

The controller may calculate a position of the second touch from the second sub-waveform.

The elastic member may include a variable resistance element, and the controller may obtain an output signal to which an amount of change in resistance between the first electrode and the second electrode is reflected.

The controller may obtain an output signal to which an amount of change in capacitance between the first electrode and the second electrode is reflected.

A method of driving a touch sensor for sensing a touch by using pressure according to one or more embodiments of the present invention includes: obtaining a touch waveform representing pressure generated by multiple touches by position when the multiple touches are concurrently input; obtaining a first sub-waveform corresponding to a peak of the touch waveform; obtaining a second sub-waveform by removing the first sub-waveform from the touch waveform; and calculating positions of the multiple touches with reference to the first sub-waveform and the second sub-waveform.

When the multiple touches include a first touch and a second touch and an intensity of the second touch is less than an intensity of the first touch, a position of the first touch may be calculated from the first sub-waveform.

A position of the second touch may be calculated from the second sub-waveform.

The second sub-waveform may be obtained with reference to a peak of the touch waveform from which the first sub-waveform is removed.

The touch waveform may be obtained by using an amount of change in capacitance generated by the multiple touches.

The touch waveform may be obtained by using an amount of change in resistance generated by the multiple touches.

According to an aspect of embodiments of the present invention, a touch sensor senses a touch by using pressure generated by the touch.

According to an aspect of embodiments of the present invention, a touch sensor correctly obtains positions and intensities of multiple touches.

### BRIEF DESCRIPTION OF THE DRAWINGS

FIG. 1 is a plan view illustrating a touch sensor according to an embodiment of the present invention;

FIG. 2 is a cross-sectional view illustrating a configuration of a pressure sensor of the touch sensor of FIG. 1;

FIGS. 3A and 3B are views illustrating an operation of the pressure sensor of FIG. 2;

FIG. 4 is a cross-sectional view illustrating a configuration of a pressure sensor according to another embodiment of the present invention;

FIGS. 5A and 5B are views illustrating an operation of the pressure sensor of FIG. 4;

FIG. 6 is a cross-sectional view illustrating a configuration of a pressure sensor according to another embodiment of the present invention;

FIGS. 7A and 7B are views illustrating an operation of the pressure sensor of FIG. 6;

FIG. 8 is a view illustrating a configuration of a touch sensor including a controller according to an embodiment of the present invention;

FIG. 9 is a view exemplarily illustrating multiple touches being concurrently input to a touch sensor according to an embodiment of the present invention;

FIGS. 10A through 10E are views exemplarily illustrating touch waveforms obtained by the controller of FIGS. 8; and

FIGS. 11A through 11D are views illustrating an operation of a controller according to an embodiment of the present invention.

### DETAILED DESCRIPTION

Some example embodiments will now be described more fully with reference to the accompanying drawings; however, the present invention may be embodied in different forms and should not be construed as limited to the embodiments set forth herein. Rather, these embodiments are provided so that this disclosure will be thorough and complete, and will full convey the scope of the present invention to those skilled in the art.

In the drawing figures, dimensions may be exaggerated for clarity of illustration. It is to be understood that when an element is referred to as being “between” two elements, it may be the only element between the two elements, or one or more intervening elements may also be present. Like reference numerals refer to like elements throughout.

Aspects and features of the present invention, and implementation methods thereof will be clarified through the following embodiments described with reference to the accompanying drawings. The present invention may, however, be embodied in different forms and should not be construed as limited to the embodiments set forth herein. Throughout this specification and the claims that follow, when it is described that an element is “connected” to another element, the element may be directly connected to the other element or connected or electrically connected to the other element through one or more third elements. In the accompanying drawings, portions irrelevant to description of the present invention may be omitted for clarity.

Herein, a touch sensor according to an embodiment of the present invention and a method of driving the same will be described with reference to the drawings related to some example embodiments of the present invention.

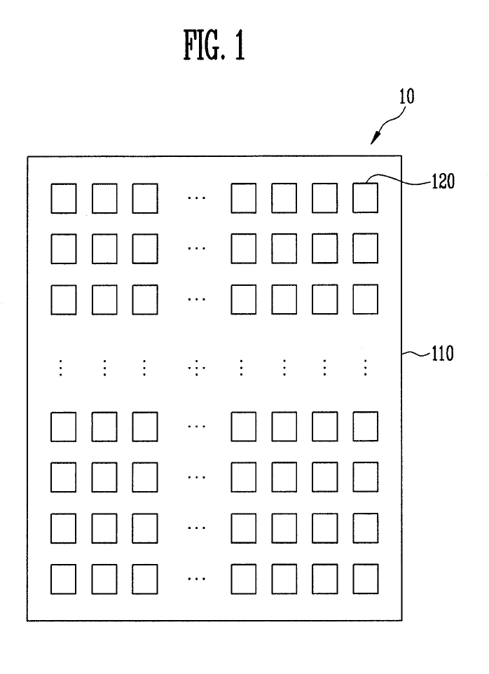

FIG. 1 is a plan view illustrating a touch sensor 10 according to an embodiment of the present invention.

Referring to FIG. 1, the touch sensor 10 according to an embodiment of the present invention may include a substrate 110 and a pressure sensor 120 positioned on the substrate 110.

The substrate 110 may be formed of an insulating material, such as glass or resin. In an embodiment, the substrate 110 may include a flexible material so as to be curved or folded, and may have a single layer structure or a multilayer structure.

For example, the substrate 110 may include at least one among polystyrene, polyvinyl alcohol, polymethyl methacrylate, polyethersulfone, polyacrylate, polyetherimide, polyethylene naphthalate, polyethylene terephthalate, polyphenylene sulfide, polyarylate, polyimide, polycarbonate, triacetate cellulose, and cellulose acetate propionate.

The material that forms the substrate 110 may be any of various materials and may include fiber glass reinforced plastic (FRP).

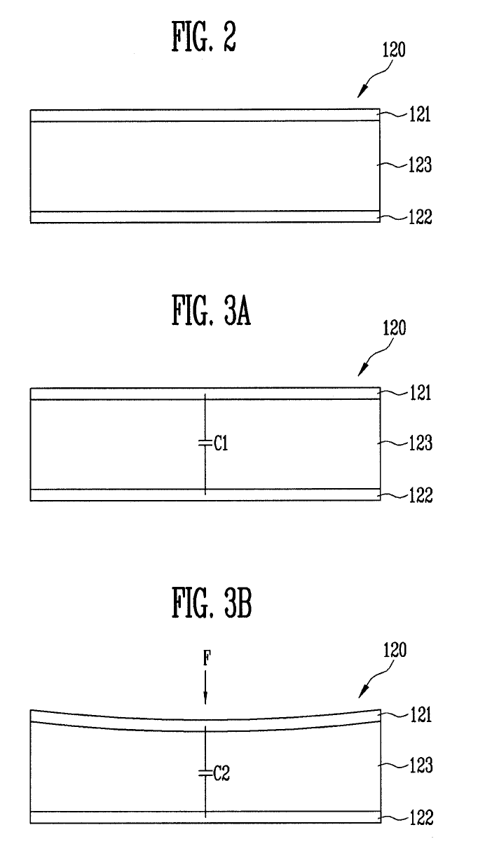

The pressure sensor 120 may sense pressure generated by a touch input onto the touch sensor 10. A configuration and an operation of the pressure sensor 120 will be described in further detail with reference to FIGS. 2 through 3B.

Although not shown in FIG. 1, wiring lines for transmitting a driving signal to the pressure sensor 120 or transmitting a sensing signal output from the pressure sensor 120 may be provided on the substrate 110.

FIG. 2 is a cross-sectional view illustrating a configuration of the pressure sensor 120 of the touch sensor 10 of FIG. 1.

Referring to FIG. 2, the pressure sensor 120 according to an embodiment of the present invention may include a first electrode 121, a second electrode 122, and a first elastic member 123 positioned between the first electrode 121 and the second electrode 122.

The first electrode 121 may include a conductive material.

According to an embodiment of the present invention, the conductive material may include any of metals or an alloy of the metals. In an embodiment, the metals may be gold (Au), silver (Ag), aluminum (Al), molybdenum (Mo), chromium (Cr), titanium (Ti), nickel (Ni), neodymium (Nd), copper (Cu), and platinum (Pt).

In an embodiment, the first electrode 121 may be formed of a transparent conductive material. The transparent conductive material may be silver nanowire (AgNW), indium tin oxide (ITO), indium zinc oxide (IZO), antimony zinc oxide (AZO), indium tin zinc oxide (ITZO), zinc oxide (ZnO), tin oxide (SnO₂), carbon nanotube, or graphene.

The first electrode 121 may be formed of a single layer or a multilayer.

The second electrode 122 is separate from the first electrode 121 and may include a conductive material. The conductive material may be selected from materials that may form the first electrode 121. The first and second electrodes 121 and 122 may be formed of the same material or different materials.

The first electrode 121 and the second electrode 122 may function as capacitors, and capacitance may be formed between the first electrode 121 and the second electrode 122.

The capacitance between the first electrode 121 and the second electrode 122 may change in accordance with a distance between the first electrode 121 and the second electrode 122.

For example, when a touch is generated on the touch sensor 10, the distance between the first electrode 121 and the second electrode 122 changes at a position corresponding to the touch such that the capacitance may change.

That is, the touch sensor 10 may sense a pressure generated by the touch by detecting an amount of change in capacitance of the pressure sensor 120.

In FIG. 2, it is illustrated that the first electrode 121 is positioned over the second electrode 122. However, the first electrode 121 may be positioned under the second electrode 122.

The first elastic member 123 may be positioned between the first electrode 121 and the second electrode 122.

In an embodiment, one surface of the first elastic member 123 contacts the first electrode 121, and the other surface, that is, an opposite surface, of the first elastic member 123 may contact the second electrode 122.

The first elastic member 123 may release or absorb external shock and may have elasticity. For example, the first elastic member 123 may have elasticity by which the first elastic member 123 is transformed by external pressure and is restored to an original state when the external pressure is removed.

In addition, the first elastic member 123 may have an insulation property in order to prevent or substantially prevent an electric short between the first electrode 121 and the second electrode 122.

In an embodiment, the first elastic member 123 may be formed of a porous polymer so as to have elasticity. For example, the first elastic member 123 may be formed of a foaming agent, such as sponge.

For example, the first elastic member 123 may include at least one among a thermoplastic elastomer, polystyrene, polyolefin, polyurethane thermoplastic elastomers, polyamides, synthetic rubbers, polydimethylsiloxane, polybutadiene, polyisobutylene, [poly(styrene-butadienestyrene)], polyurethanes, polychloroprene, polyethylene, silicon, and combinations of the above materials. However, the present invention is not limited thereto.

Although not shown in FIG. 2, wiring lines may be connected to the first electrode 121 and the second electrode 122. The first electrode 121 or the second electrode 122 may receive a driving signal through the wiring lines or may output a signal to the wiring lines.

FIGS. 3A and 3B are views illustrating an operation of the pressure sensor of

FIG. 2. FIG. 3A illustrates a state in which a pressure F is not applied to the pressure sensor 120; and FIG. 3B illustrates a state in which the pressure F is applied to the pressure sensor 120.

Referring to FIG. 3A, when the pressure F is not applied to the pressure sensor 120, a first capacitance Cl may be formed between the first electrode 121 and the second electrode 122.

Referring to FIG. 3B, when the pressure F is applied to the pressure sensor 120 due to a touch of a user, the distance between the first electrode 121 and the second electrode 122 changes such that the capacitance between the first electrode 121 and the second electrode 122 may change.

For example, when the distance between the first electrode 121 and the second electrode 122 changes due to the applied pressure F, the first capacitance C1 may change into a second capacitance C2.

As a result, as the pressure F increases, the distance between the first electrode 121 and the second electrode 122 is reduced and the capacitance between the first electrode 121 and the second electrode 122 may increase.

Therefore, an intensity of the pressure F may be detected by using the amount of change in capacitance reflected to the output signal of the pressure sensor 120. The pressure F applied to the pressure sensor 120 may be mainly generated by the touch of the user. However, the present invention is not limited thereto. For example, the pressure F applied to the pressure sensor 120 may be generated by other various causes.

FIG. 4 is a cross-sectional view illustrating a configuration of a pressure sensor 120′ according to another embodiment of the present invention.

Referring to FIG. 4, the pressure sensor 120′ according to another embodiment of the present invention may include the first electrode 121, the second electrode 122, and a second elastic member 124.

The first electrode 121 and the second electrode 122 may be separate from each other.

The second elastic member 124 may be positioned between the first electrode 121 and the second electrode 122.

The second elastic member 124 may be an element of which an electrical characteristic changes in accordance with a degree of transformation. In particular, the second elastic member 124 may include a variable resistance element of which resistance changes in accordance with external pressure.

In an embodiment, for example, as a force provided to the second elastic member 124 increases, a resistance of the second elastic member 124 may be reduced. In another embodiment, as the force provided to the second elastic member 124 increases, the resistance of the second elastic member 124 may increase.

That is, the pressure generated by the touch may be sensed by detecting an amount of change in resistance of the pressure sensor 120′.

Accordingly, the second elastic member 124 may include a material referred to as a force sensitive material or a force sensitive resistor.

The second elastic member 124 may include at least one among piezo-electric materials, such as lead zirconate titanate (PZT), BaTiO₃, polytrifluoroethylene (PTrFE), or polyvinylidene fluoride (PVDF), piezo-electric semiconductors, such as polycrystal, PMN-PT single crystal, ZnO, or MoS₂, carbon powder, quantum tunneling composite (QTC), silicon, carbon nanotube, and graphene.

In an embodiment, the second elastic member 124 may include nanoparticles. For example, the nanoparticles may be provided as a nanotube, a nano-column, a nano-rod, nano-pore, or nanowire.

The nanoparticles may include particles of carbon, graphite, metamorphosis metalloid, metal, a conductive oxide of the metamorphosis metalloid or the metal, or a conductive nitride of metamorphosis metalloid or the metal, or may include core shell structured particles in which the particles are coated on an insulating bead or a combination of the above particles. The metamorphosis metalloid may include one of antimony (Sb), germanium (Ge), and arsenic (As), or an alloy of the above metals. The metal may include zinc (Zn), aluminum (Al), scandium (Sc), chromium (Cr), manganese (Mn), iron (Fe), cobalt (Co), nickel (Ni), copper (Cu), indium (In), tin (Sn), yttrium (Y), zirconium (Zr), niobium (Nb), molybdenum (Mo), ruthenium (Ru), rhodium (Rh), palladium (Pd), gold (Au), silver (Ag), platinum (Pt), strontium (Sr), tungsten (W), cadmium (Cd), tantalum (Ta), titanium (Ti), or an alloy of the above metals. The conductive oxide may include indium tin oxide (ITO), indium zinc oxide (IZO), aluminum doped zinc oxide (AZO), gallium indium zinc oxide (GIZO), zinc oxide (ZnO), or a mixture of the above oxides.

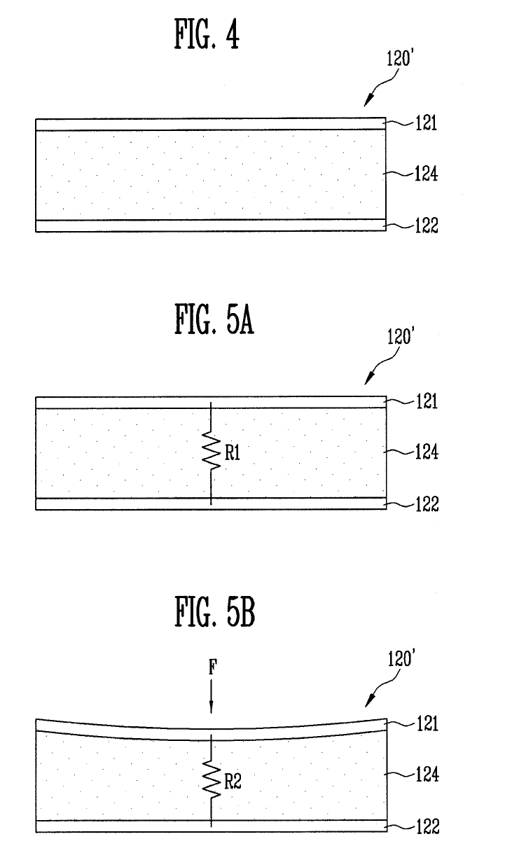

FIGS. 5A and 5B are views illustrating an operation of the pressure sensor 120′ of FIG. 4. In particular, FIG. 5A illustrates a state in which the pressure F is not applied to the pressure sensor 120′; and FIG. 5B illustrates a state in which the pressure F is applied to the pressure sensor 120′.

Referring to FIG. 5A, when the pressure F is not applied to the pressure sensor 120′, the first electrode 121 and the second electrode 122 are separate from each other by a first distance with the second elastic member 124 interposed therebetween, and the second elastic member 124 may have a first resistance R1.

Referring to FIG. 5B, when the pressure F is applied to the pressure sensor 120′, such as due to the touch of the user, the distance between the first electrode 121 and the second electrode 122 changes such that a shape of the second elastic member 124 may change.

Therefore, the resistance of the second elastic member 124 may change, for example, from the first resistance R1 to a second resistance R2.

As the pressure F increases, the second elastic member 124 is transformed to a greater degree and the amount of change in resistance of the second elastic member 124 may increase.

Therefore, a position and intensity of the pressure F may be detected with reference to the amount of change in resistance reflected to the output signal of the pressure sensor 120′.

FIG. 6 is a cross-sectional view illustrating a configuration of a pressure sensor 120″ according to another embodiment of the present invention.

Referring to FIG. 6, the pressure sensor 120″ according to another embodiment of the present invention may include the first electrode 121, the second electrode 122, and the second elastic member 124.

The first electrode 121 and the second electrode 122 may be positioned to be separate from each other on a same plane.

The second elastic member 124 may be positioned between the first electrode 121 and the second electrode 122. When the second elastic member 124 is transformed by an external pressure, the resistance value of the second elastic member 124 may change.

That is, the pressure generated by the touch may be sensed by detecting an amount of change in resistance of the pressure sensor 120″.

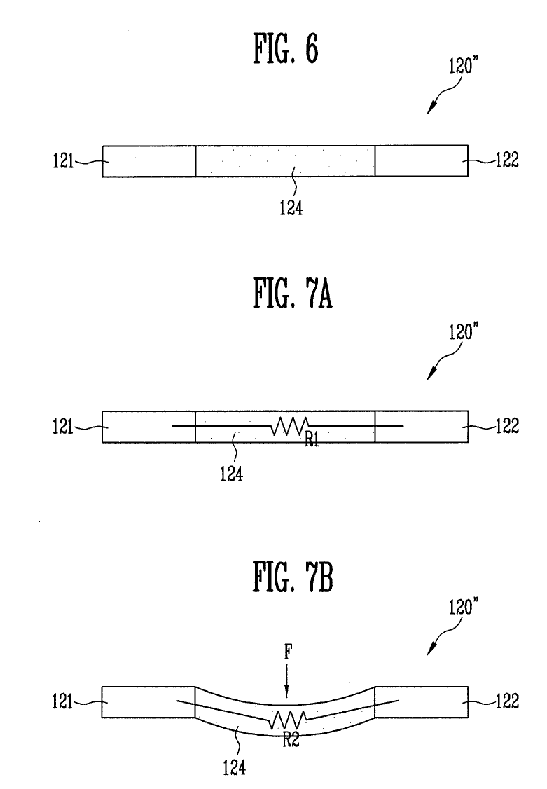

FIGS. 7A and 7B are views illustrating an operation of the pressure sensor of FIG. 6. In particular, FIG. 7A illustrates a state in which the pressure F is not applied to the pressure sensor 120″; and FIG. 7B illustrates a state in which the pressure F is applied to the pressure sensor 120″.

Referring to FIG. 7A, when the pressure F is not applied to the pressure sensor 120″, the second elastic member 124 is not transformed and may have the first resistance R1.

Referring to FIG. 7B, when the pressure F is applied to the pressure sensor 120″ due to the touch of the user, the shape of the second elastic member 124 may change.

Therefore, the resistance of the second elastic member 124 may change, for example, from the first resistance R1 to the second resistance R2.

As the pressure F increases, the second elastic member 124 is transformed to a greater degree and the amount of change in resistance of the second elastic member 124 may increase.

Therefore, a position and intensity of the pressure F may be detected with reference to the amount of change in resistance reflected to a sensing signal output from the pressure sensor 120″.

According to other embodiments, the shape of the pressure sensor 120 is not limited to the shapes illustrated in FIGS. 1 through 7B, and may be any of various shapes.

In another embodiment, for example, the first electrode 121 and the second electrode 122 may be bar-shaped. In this case, the first elastic member 123 or the second elastic member 124 may be positioned in an area in which the first electrode 121 and the second electrode 122 intersect.

FIG. 8 is a view illustrating a configuration of a touch sensor including a controller according to an embodiment of the present invention. In FIG. 8, for the sake of convenience, the elastic members 123 and 124 are not shown.

The controller 130 may apply a driving signal to the first electrode 121 and the second electrode 122 such that the pressure sensor 120 is driven.

The controller 130 may detect pressure applied onto the touch sensor 10 by sensing an amount (for example, |C2-C1|) of change in capacitance that exists between the first electrode 121 and the second electrode 122.

For example, the controller 130 may obtain the amount of change in capacitance by using the output signal of the first electrode 121.

The controller 130 may calculate a position and intensity of the touch input onto the touch sensor 10 with reference to a position of the pressure sensor 120 that outputs a signal to which the amount of change in capacitance is reflected and the amount of change in capacitance.

The controller 130 may obtain a touch waveform that represents the pressure generated by the touch by position by using the output signal of the first electrode 121. That is, according to an embodiment, the touch waveform may represent the intensity of the touch by a function of a position.

The controller 130 may calculate the position and intensity of the touch with reference to a peak of the touch waveform. The controller 130 according to an embodiment of the present invention may sense multiple touches in which a plurality of touches are concurrently (e.g., simultaneously) input, as well as a single touch.

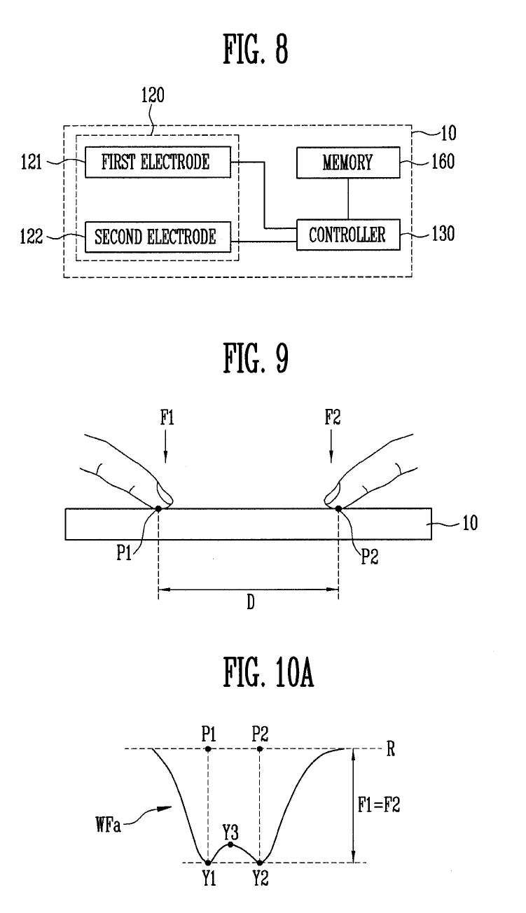

An operation of the controller 130 for sensing the multiple touches will be described in further detail with reference to FIGS. 9 through 11D.

In an embodiment, it is described above that the controller 130 of FIG. 8 may calculate the position and intensity of the touch by using the amount of change in capacitance. However, the present invention is not limited thereto.

For example, the controller 130 may calculate the position and intensity of the touch by using an amount (for example, |R2-R1|) of change in resistance between the first electrode 121 and the second electrode 122.

FIG. 9 is a view exemplarily illustrating multiple touches being concurrently input to a touch sensor according to an embodiment of the present invention.

Referring to FIG. 9, the multiple touches may include a first touch T1 and a second touch T2 concurrently (e.g., simultaneously) input to the touch sensor 10.

The first touch T1 may be input onto a first position P1 with a first intensity F1 The second touch T2 may be input onto a second position P2 separate from the first position P1 by a first distance D with a second intensity F2.

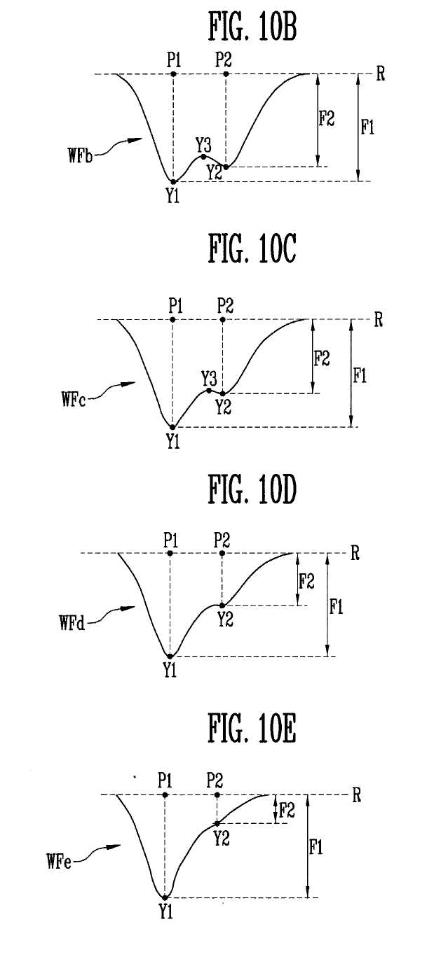

FIGS. 10A through 10E are views exemplarily illustrating touch waveforms obtained by the controller of FIG. 8. In particular, FIGS. 10A through 10E illustrate touch waveforms corresponding to the multiple touches of FIG. 9.

In addition, FIGS. 10A through 10E illustrate touch waveforms that change as the first position P1, the second position P2, the first distance D between the first position P1 and the second position P2, and the first intensity F1 of the first touch T1 do not change and the second intensity F2 of the second touch T2 changes in the multiple touches of FIG. 9.

A reference line R illustrated in each of FIGS. 10A through 10E represents that the touch is not input to the touch sensor 10. As the intensity of the touch input to the touch sensor 10 increases, a distance between the reference line R and the touch waveform may increase.

FIG. 10A illustrates a touch waveform WFa obtained by the controller 130 when the first intensity F1 of the first touch T1 and the second intensity F2 of the second touch T2 of FIG. 9 are equal to each other.

The touch waveform WFa may have a shape obtained by combining the touch waveform generated by the first touch T1 and the touch waveform generated by the second touch T2. That is, the touch waveform generated by the multiple touches may include waveforms corresponding to the respective touches.

Referring to FIG. 10A, the touch waveform WFa may include two ridges Y1 and Y2 and a valley Y3 positioned between the two ridges Y1 and Y2.

The first ridge Y1 may correspond to the first position P1 of the first touch T1, and the second ridge Y2 may correspond to the second position P2 of the second touch T2.

A distance between the reference line R and the first ridge Y1 may correspond to the first intensity F1, and a distance between the reference line R and the second ridge Y2 may correspond to the second intensity F2.

In the present example, since the first intensity F1 and the second intensity F2 are equal, the distance between the reference line R and the first ridge Y1 and the distance between the reference line R and the second ridge Y2 may be equal to each other.

FIG. 10B illustrates a touch waveform WFb obtained by the controller 130 when the first intensity F1 of the first touch T1 of FIG. 9 is larger than the second intensity F2 of the second touch T2 of FIG. 9. In the present example, the second intensity F2 may be 80% of the first intensity F1.

Referring to FIG. 10B, the touch waveform WFb may include two ridges Y1 and Y2 and a valley Y3 positioned between the two ridges Y1 and Y2.

A distance between the valley Y3 and the second ridge Y2 of the touch waveform WFb of FIG. 10B may be smaller than a distance between the valley Y3 and the second ridge Y2 of the touch waveform WFa of FIG. 10A.

The first ridge Y1 may correspond to the first position P1 of the first touch T1, and the second ridge Y2 may correspond to the second position P2 of the second touch T2.

A distance between the reference line R and the first ridge Y1 may correspond to the first intensity F1, and a distance between the reference line R and the second ridge Y2 may correspond to the second intensity F2.

In the present example, since the first intensity F1 is larger than the second intensity F2, the distance between the reference line R and the first ridge Y1 may be larger than the distance between the reference line R and the second ridge Y2.

FIG. 10C illustrates a touch waveform WFc obtained by the controller 130 when the first intensity F1 of the first touch T1 of FIG. 9 is larger than the second intensity F2 of the second touch T2 of FIG. 9. In the present example, the second intensity F2 may be 60% of the first intensity F1.

Referring to FIG. 10C, the touch waveform WFc may include two ridges Y1 and Y2 and a valley Y3 positioned between the two ridges Y1 and Y2.

A distance between the valley Y3 and the second ridge Y2 of the touch waveform WFc of FIG. 10C may be smaller than a distance between the valley Y3 and the second ridge Y2 of the touch waveform WFb of FIG. 10B.

The first ridge Y1 may correspond to the first position P1 of the first touch T1, and the second ridge Y2 may correspond to the second position P2 of the second touch T2.

A distance between the reference line R and the first ridge Y1 may correspond to the first intensity F1, and a distance between the reference line R and the second ridge Y2 may correspond to the second intensity F2.

In the present example, since the first intensity F1 is larger than the second intensity F2, the distance between the reference line R and the first ridge Y1 may be larger than the distance between the reference line R and the second ridge Y2.

FIG. 10D illustrates a touch waveform WFd obtained by the controller 130 when the first intensity F1 of the first touch T1 of FIG. 9 is larger than the second intensity F2 of the second touch T2 of FIG. 9. In the present example, the second intensity F2 may be 40% of the first intensity F1.

Referring to FIG. 10D, the touch waveform WFd may include a first ridge Y1.

The first ridge Y1 may correspond to the first position P1 of the first touch T1.

A distance between the reference line R and the first ridge Y1 may correspond to the first intensity F1.

As a difference between the first intensity F1 of the first touch T1 and the second intensity F2 of the second touch T2 increases, the valley Y3 and the second ridge Y2 included in the waveforms WFa, WFb, and WFc of FIGS. 10A through 10C may not be shown in the touch waveform WFd, or the second ridge Y2 may be shown as a plateau.

That is, it may be difficult to know the number of input touches only by the touch waveform WFd.

FIG. 10E illustrates a touch waveform WFe obtained by the controller 130 when the first intensity F1 of the first touch T1 of FIG. 9 is larger than the second intensity F2 of the second touch T2 of FIG. 9. In the present example, the second intensity F2 may be 20% of the first intensity F1.

Referring to FIG. 10E, the touch waveform WFe may include a first ridge Y1.

The first ridge Y1 may correspond to the first position P1 of the first touch T1.

A distance between the reference line R and the first ridge Y1 may correspond to the first intensity F1.

As a difference between the first intensity F1 of the first touch T1 and the second intensity F2 of the second touch T2 increases, the valley Y3 and the second ridge Y2 included in the waveforms WFa, WFb, and WFc of FIGS. 10A through 10C may not be shown in the touch waveform WFe, or the second ridge Y2 may be shown as a plateau.

That is, it may be difficult to know the number of input touches only by the touch waveform WFe.

Referring to FIGS. 10A through 10C, when the multiple touches include the two touches (that is, the first touch T1 and the second touch T2), the controller 130 may sense the two touches by using the two ridges Y1 and Y2 distinguished from each other in the touch waveform.

As the difference between the first intensity F1 of the first touch T1 and the second intensity F2 of the second touch T2 increases, a difference between the valley Y3 and the second ridge Y2 is reduced and, as illustrated in FIGS. 10D and 10E, the valley Y3 and the second ridge Y2 may not be included in the touch waveform.

That is, the touch sensor 10 that senses a touch by using the pressure generated by the touch may consider that one touch is input when an intensity of one of the multiple touches is small.

In an embodiment, as the first distance D between the first position P1 and the second position P2 is smaller, the distance between the valley Y3 and the second ridge Y2 may be reduced. That is, as the first distance D between the first position P1 and the second position P2 is smaller, it may be more difficult to distinguish the multiple touches from each other.

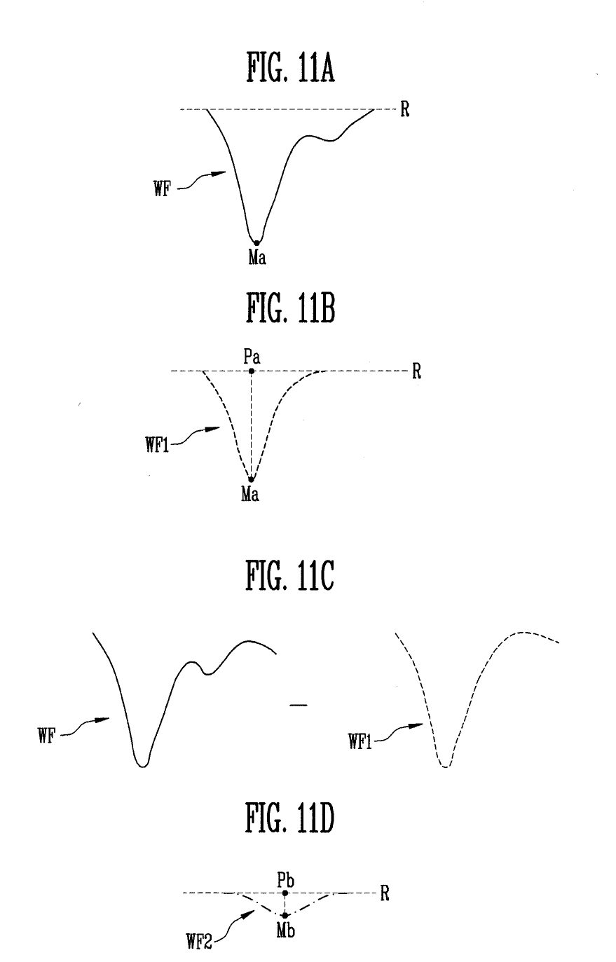

FIGS. 11A through 11D are views illustrating an operation of a controller according to an embodiment of the present invention.

FIG. 11A exemplarily illustrates a touch waveform WF corresponding to the multiple touches concurrently (e.g., simultaneously) input to the touch sensor 10.

When the multiple touches are concurrently or simultaneously input to the touch sensor 10, the controller 130 may obtain the touch waveform WF generated by the multiple touches by using the amount of change in capacitance reflected to the output signal of the first electrode 121.

FIG. 11B exemplarily illustrates a first sub-waveform WF1 included in the touch waveform WE of FIG. 11A.

The controller 130 determines a peak Ma of the touch waveform WF and may obtain the first sub-waveform WF1 corresponding to the peak Ma.

Here, the peak Ma may be a point farthest from the reference line R in the touch waveform WF. In particular, the peak Ma may be a ridge corresponding to a first touch with the largest intensity among the multiple touches.

In addition, the first sub-waveform WF1 may be a touch waveform corresponding to the first touch with the largest intensity among the multiple touches.

Referring to FIG. 8, the touch sensor 10 may further include a memory 160 for storing information on the first sub-waveform WF1 corresponding to a size of the peak Ma.

Here, the size of the peak Ma may be a distance between the peak Ma and the reference line R.

The controller 130 obtains the size of the peak Ma from the touch waveform WF and may obtain the first sub-waveform WF1 corresponding to the size of the peak Ma from the memory 160.

The controller 130 may calculate a position of the first touch by using the first sub-waveform WF1.

For example, a position Pa corresponding to the peak Ma of the first sub-waveform WF1 is calculated as the position of the first touch and the intensity of the first touch may be calculated by using the size of the peak Ma.

Next, referring to FIG. 11C, the controller 130 may remove the first sub-waveform WF1 from the touch waveform WF.

The controller 130 may obtain a second sub-waveform WF2 of FIG. 11D by using a peak Mb of the touch waveform WF from which the first sub-waveform WF1 is removed.

Here, the second sub-waveform WF2 may be a touch waveform corresponding to the second touch with the second largest intensity among the multiple touches.

The controller 130 may obtain the second sub-waveform WF2 corresponding to a size of the peak Mb of the touch waveform WF from which the first sub-waveform WF1 is removed from the memory 160.

The controller 130 may calculate a position of the second touch by using the second sub-waveform WF2.

For example, a position Pb corresponding to the peak Mb of the second sub-waveform WF2 is calculated as the position of the second touch, and the intensity of the second touch may be calculated by using the size of the peak Mb.

When the multiple touches include two touches, the touch waveform WF from which the first sub-waveform WF1 is removed may be the second sub-waveform WF2.

When the multiple touches include three touches, the controller 130 may obtain a third sub-waveform corresponding to a third touch with the smallest intensity among the multiple touches by obtaining the second sub-waveform WF2 corresponding to the peak of the touch waveform WF from which the first sub-waveform WF1 is removed and removing both the first sub-waveform WF1 and the second sub-waveform WF2 from the touch waveform WF.

According to the embodiment of the present invention, although the multiple touches with different intensities are input, the respective multiple touches may be correctly sensed. In particular, although a difference in intensity among the multiple touches may be large or the multiple touches are input to positions adjacent to one another, the respective multiple touches may be correctly sensed.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A touch sensor comprising:
a plurality of first electrodes positioned on a substrate;
a plurality of second electrodes positioned on the substrate to be separate from the plurality of first electrodes;
an elastic member positioned between the plurality of first electrodes and the plurality of second electrodes; and
a controller to apply a driving signal to the plurality of first electrodes and the plurality of second electrodes and to obtain an output signal of the plurality of first electrodes,
wherein a shape of the elastic member is changeable in accordance with a pressure, and
wherein the controller obtains a touch waveform corresponding to concurrently input multiple touches and calculates positions of the multiple touches with reference to a peak of the touch waveform.

2. The touch sensor of claim 1, wherein the touch waveform represents an intensity of a touch by a position function.

3. The touch sensor of claim 1, wherein the controller obtains a touch waveform corresponding to the multiple touches with reference to the output signal.

4. The touch sensor of claim 3, wherein the controller obtains a first sub-waveform corresponding to a peak of the touch waveform.

5. The touch sensor of claim 4, wherein the controller obtains a second sub-waveform by removing the first sub-waveform from the touch waveform.

6. The touch sensor of claim 5, wherein, when the multiple touches comprise a first touch and a second touch and an intensity of the second touch is less than an intensity of the first touch, the controller calculates a position of the first touch from the first sub-waveform.

7. The touch sensor of claim 6, wherein the controller obtains the second sub-waveform with reference to a peak of the touch waveform from which the first sub-waveform is removed.

8. The touch sensor of claim 7, wherein the controller calculates a position of the second touch from the second sub-waveform.

9. The touch sensor of claim 1,
wherein the elastic member comprises a variable resistance element, and
wherein the controller obtains an output signal to which an amount of change in resistance between the first electrode and the second electrode is reflected.

10. The touch sensor of claim 1, wherein the controller obtains an output signal to which an amount of change in capacitance between the first electrode and the second electrode is reflected.

11. A method of driving a touch sensor configured to sense a touch by using pressure, the method comprising:
obtaining a touch waveform representing pressure generated by multiple touches by position when the multiple touches are concurrently input;
obtaining a first sub-waveform corresponding to a peak of the touch waveform;
obtaining a second sub-waveform by removing the first sub-waveform from the touch waveform; and
calculating positions of the multiple touches with reference to the first sub-waveform and the second sub-waveform.

12. The method of claim 11, wherein, when the multiple touches comprise a first touch and a second touch and an intensity of the second touch is less than an intensity of the first touch, a position of the first touch is calculated from the first sub-waveform.

13. The method of claim 12, wherein a position of the second touch is calculated from the second sub-waveform.

14. The method of claim 12, wherein the second sub-waveform is obtained with reference to a peak of the touch waveform from which the first sub-waveform is removed.

15. The method of claim 11, wherein the touch waveform is obtained by using an amount of change in capacitance generated by the multiple touches.

16. The method of claim 11, wherein the touch waveform is obtained by using an amount of change in resistance generated by the multiple touches.
